(19) United States
(12) Patent Application Publication
(10) Pub. No.: US 2009/0068564 A1
(43) Pub. Date: Mar. 12, 2009

(54) METHOD OF DESIGNING COMPOSITION OF LIQUID ELECTROLYTE FOR HIGH CHARGE/DISCHARGE RATE

(75) Inventors: Young-Gi Lee, Daejeon-city (KR); Kwang Man Kim, Daejeon-city (KR); Mangu Kang, Daejeon-city (KR); Jongdae Kim, Daejeon-city (KR)

Correspondence Address: RABIN & Berdo, PC, 1101 14TH STREET, NW, SUITE 500, WASHINGTON, DC, 20005, US

(73) Assignee: Electronics and Telecommunications Research Institute, Daejeon-city (KR)

(21) Appl. No.: 12/039,102

(22) Filed: Feb. 28, 2008

(30) Foreign Application Priority Data
Sep. 6, 2007 (KR) 10-2007-0090549

(51) Int. Cl. H01M 6/16

(52) U.S. Cl. 429/331; 429/324; 429/332

(57) ABSTRACT

Provided is a method of designing an electrolyte composition including a nonaqueous organic solvent mixture and a lithium salt to obtain an optimal composition ratio of components of the electrolyte composition for a high charging/high-output discharging secondary battery. The method includes: selecting components of the nonaqueous organic solvent mixture; determining composition ratio ranges of the selected components satisfying such conditions that an average dielectric constant, an average viscosity, and an average boiling point satisfy predetermined boundary values; dividing the ranges of the composition ratios into a plurality of groups; selecting a representative composition ratio of each of the groups; adding a lithium salt to a nonaqueous organic solvent mixture having the representative composition ratio to prepare an electrolyte composition; and measuring properties of the electrolyte composition to determine a composition ratio of an electrolyte composition having predetermined properties.

### CROSS-REFERENCE TO RELATED PATENT APPLICATIONS

This application claims the benefit of Korean Patent Application No. 10-2007-0090549, filed on Sep. 6, 2007, in the Korean Intellectual Property Office, the disclosure of which is incorporated herein in its entirety by reference.

### BACKGROUND OF THE INVENTION

1. Field of the Invention

The present invention relates to a lithium secondary battery, and more particularly, to a method of designing a composition of a liquid electrolyte for a lithium secondary battery.

The present invention was supported by the Information Technology (IT) New Growing Power Core Technique Development program of the Ministry of Information and Communication (MIC). [Project No.: 2006-S-006-02, project title: Ubiquitous terminal components module].

2. Description of the Related Art

Due to rapid developments in the electrical, electronic, communication, and computer industries, demands for a secondary battery having high performance and high stability are gradually increasing. In particular, electrical devices are manufactured to be small, thin, and lightweight. As for office automation, desktop computers are being replaced with small and lightweight notebook computers. In addition, portable electrical devices, such as camcorders or cellular phones, are widely used. As electronic devices are manufactured to be small, thin, and lightweight, there is a need to develop secondary batteries, which supply electric power to the electronic devices, having high performance. Therefore, lithium secondary batteries may replace conventional lead storage batteries or Ni—Cd batteries. The lithium secondary batteries can be installed in small and lightweight products, have high energy density, and can be repeatedly charged and discharged thereby actively being developed.

In a lithium secondary battery, electrical energy is generated through oxidation/reduction occurring when lithium ions are intercalated/deintercalated at a cathode and an anode. A lithium secondary battery includes: a cathode and an anode prepared using an active material enabling intercalation and deintercalation of lithium ions; and an organic electrolyte solution or polymer electrolyte through which lithium ions flow between the cathode and the anode. The cathode of a lithium secondary battery has a greater potential by about 3 to 4.5 V than that of an electrode potential of lithium. The cathode can be formed of a complex oxide of a transition metal and lithium, which enables intercalation/ deintercalation of lithium ions. A material for the cathode may be lithium cobalt oxide (LiCoO₂), lithium nickel oxide(LiNiO₂), or lithium magnesium oxide (LiMnO₂). The anode may be formed of a lithium metal or lithium alloy which can reversibly accept or supply lithium ions while maintaining structural and electrical properties, or a carbon-based material which has a chemical potential similar to that of a metal lithium when lithium ions intercalates/deintercalates.

Meanwhile, lithium secondary batteries may be categorized into conventional lithium ion batteries (LIB) having a liquid electrolyte/separator, and lithium polymer batteries (LPB) having a polymer electrolyte, according to the type of electrolyte used. Lithium polymer batteries can be sub-categorized into lithium metal polymer batteries (LMPB) in which lithium metal is used for an anode, and lithium ion polymer batteries (LIPB) in which carbon is used for an anode.

Conventional LIBs having a liquid electrolyte are being developed to obtain a high-energy density and to obtain high-speed charging properties and high output discharging properties. In order to obtain the high-energy density, the improvements of manufacturing processes and materials are required. In order to obtain high-speed charging properties and high-output discharging properties, it is very important to consider the characteristics of liquid electrolyte and a separator as well as the electrolyte structure. Specifically, with respect to a liquid electrolyte, it is very important to develop a solvent having a high dielectric constant to obtain high ionic conductivity, a solvent having a low viscosity to obtain high-speed charging and high-speed discharging properties, and an electrolyte having high boiling point to obtain thermal stability.

A conventional liquid electrolyte is prepared by dissolving 1 M lithium hexafluorophosphate (LiPF₆) in a two-component-based or three-component-based nonaqueous organic solvent mixture. The two-component-based liquid electrolyte composition may be prepared by dissolving 1 M lithium hexafluorophosphate (LiPF₆) in an organic solvent mixture of ethylene carbonate and dimethyl carbonate in a weight ratio of 50:50. The three-component-based liquid electrolyte composition may be prepared by dissolving 1 M lithium hexafluorophosphate (LiPF₆) in an organic solvent mixture of ethylene carbonate, dimethyl carbonate, and diethyl carbonate in a weight ratio of 20:20:60. These commercially available liquid electrolytes have an ionic conductivity of 8.8×10⁻³ S/cm to 1.1×10⁻² S/cm (25° C.) and a viscosity of 2.4 to 4.2 cP (25° C.).

Ethylene carbonate has high dielectric properties and thus is necessary for dissociation of lithium ions, but has high viscosity. Dimethyl carbonate is used together with ethylene carbonate so as to reduce viscosity of a liquid electrolyte at room temperature. However, when dimethyl carbonate is used for a long period of time, dimethyl carbonate causes a polyvinylidene fluoride binder contained in an electrode to swell. Also, dimethyl carbonate can be partially evaporated when the temperature of a device increases to 80° C. or higher, and thus, dimethyl carbonate cannot be used at high temperature. Meanwhile, diethyl carbonate or ethylmethyl carbonate can be partially used to improve high temperature stability of a liquid electrolyte and to increase the lifetime. Such use of diethyl carbonate or ethylmethyl carbonate, however, rather decreases ionic conductivity and increases viscosity of a liquid electrolyte. That is, despite many efforts including those described above, commercially available two-component-based and three-component-based liquid electrolytes are not suitable for high-speed charging and high-output discharging characteristics due to high viscosity even though they are suitable for a high-energy density battery. Specifically, in consideration of ultra high-speed charging within a few minutes and high-output discharging properties, reducing viscosity is a more important issue.

### SUMMARY OF THE INVENTION

The present invention provides a method of designing a composition of a liquid electrolyte including a multi-component nonaqueous organic solvent, which has high ionic conductivity, low viscosity, and a high boiling point, and is therefore suitable for a liquid secondary battery requiring high-speed charging and high-output discharging characteristics.

According to the present invention, a composition ratio of components of a multi-component liquid electrolyte for a lithium secondary battery may be optimized such that the average dielectric constant, average viscosity, average boiling point of the multi-component liquid electrolyte are adjusted within desired ranges.

According to the present invention, there is provided a method of designing a composition ratio of a liquid electrolyte including a nonaqueous organic solvent mixture and a lithium salt, including: selecting components of the nonaqueous organic solvent mixture; determining composition ratio ranges of the selected components satisfying Formulae 1 through 4 below; dividing the ranges of the composition ratios into a plurality of groups; selecting a representative composition ratio of each of the groups; adding a lithium salt to the nonaqueous organic solvent mixture having the representative composition ratio to form an electrolyte composition; and measuring properties of the electrolyte composition to determine a composition ratio of the electrolyte composition having desired properties:

Sxᵢeᵢ≧dielectric constant boundary value; Formula 1:

Sxᵢhᵢ≦viscosity boundary value; Formula 2:

SxᵢT_{b}≧boiling point boundary value; and Formula 3:

0≦xᵢ≦1 Formula 4:

where i denotes a component i in the nonaqueous organic solvent mixture, xᵢ denotes a composition ratio of the component i, eᵢ denotes dielectric constant of the component i, hᵢ denotes viscosity of the component i, and T_{bi} denotes a boiling point of the component i)

The dielectric boundary value may be 48, the viscosity boundary value may be 1.30, and the boiling point boundary value may be 80.

The nonaqueous mixture organic solvent mixture may include ethylene carbonate, dimethyl carbonate, and one or more materials selected from the group consisting of diethyl carbonate, ethylmethyl carbonate, dimethyl formamide, tetrahydrofurane, dimethylacetyl amide, n-butyl cabitol, n-methyl pyrrolidone, 1,3-dioxolane, dimehtyl ether, diethyl ether, and dimethyl sulfoxide.

The lithium salt is added in a concentration of 0.1 M to 3M.

The lithium salt includes one or more materials selected from the group consisting of lithium perchlorate(LiClO₄), lithium triflate(LiCF₃SO₃), lithium hexafluorophosphate(LiPF₆), lithium tetrafluoroborate(LiBF₄) and lithium trifluoromethanesulfonimide (LiN(CF₃SO₂)₂).

The dividing is performed with a boundary of the plurality of groups where the change in the composition ratio is large in the ranges of the composition ratios. Properties of the electrolyte composition comprise viscosity, ionic conductivity, and a specific capacity of a single cell unit.

### BRIEF DESCRIPTION OF THE DRAWINGS

The above and other features and advantages of the present invention will become more apparent by describing in detail exemplary embodiments thereof with reference to the attached drawings in which:

FIG. 1 is a flow chart illustrating a method of designing a composition of a liquid electrolyte for a high-speed charging/high-output discharging device according to an embodiment of the present invention;

FIG. 2 shows formulae used in an optimization program for a composition ratio simulation of a liquid electrolyte according to the present invention;

FIG. 3 shows three-component-based optimization results of a liquid electrolyte according to an embodiment of the present invention;

FIG. 4 is a graph of viscosity of liquid electrolytes for a high-speed charging/high-output discharging device, prepared according to Examples 1 through 5 and Comparative Examples 1 and 2;

FIG. 5 is a graph of ionic conductivity of the liquid electrolytes prepared according to Examples 1 through 5 and Comparative Examples 1 and 2; and

FIG. 6 is a graph illustrating high-rate discharging characteristics of cells including the liquid electrolytes prepared according to Examples 1 through 5 and Comparative Examples 1 and 2.

### DETAILED DESCRIPTION OF THE INVENTION

The present invention will now be described more fully with reference to the accompanying drawings, in which exemplary embodiments of the invention are shown. The invention may, however, be embodied in many different forms and should not be construed as being limited to the embodiments set forth herein; rather, these embodiments are provided so that this disclosure will be thorough and complete, and will fully convey the concept of the invention to those skilled in the art. In the drawings, the thicknesses of layers and regions are exaggerated for clarity. Like reference numerals in the drawings denote like elements, and thus their description will be omitted.

A liquid electrolyte according to an embodiment of the present invention includes a nonaqueous organic solvent mixture and a lithium salt. The nonaqueous organic solvent mixture includes ethylene carbonate, dimethyl carbonate, and other organic solvents. The ethylene carbonate dissociates the lithium salt to have ionic conductivity, and the dimethyl carbonate dissolves solid ethylene carbonate and reduces viscosity of the liquid electrolyte. The other organic solvents may include one or more compounds, having a high dielectric constant, high boiling point, and low viscosity, selected from the group consisting of diethyl carbonate, ethyl methyl carbonate, dimethylformamide, tetrahydrofuran, dimethyl acetylamide, n-butyl cabitol, n-methylpyrrolidone, 1,3-dioxolane, dimethyl ether, diethyl ether, and dimethyl sulfoxide. The amount of ethylene carbonate in the liquid electrolyte may be 10 to 60% by weight, the amount of dimethyl carbonate in the liquid electrolyte may be 10 to 50% by weight, and the amount of other solvents in the liquid electrolyte may be 1 to 50% by weight.

The lithium salt may have a concentration of 0.1 to 3 M and may be lithiumperchlorate(LiClO₄), lithiumtriplate(LiCF₃SO₃), lithiumhexafluorophosphate(LiPF₆), lithiumtetrafluoroborate(LiBF₄), lithiumtrifluorometanesulfonylimide(LiN(CF₃SO₂)₂) or a combination thereof.

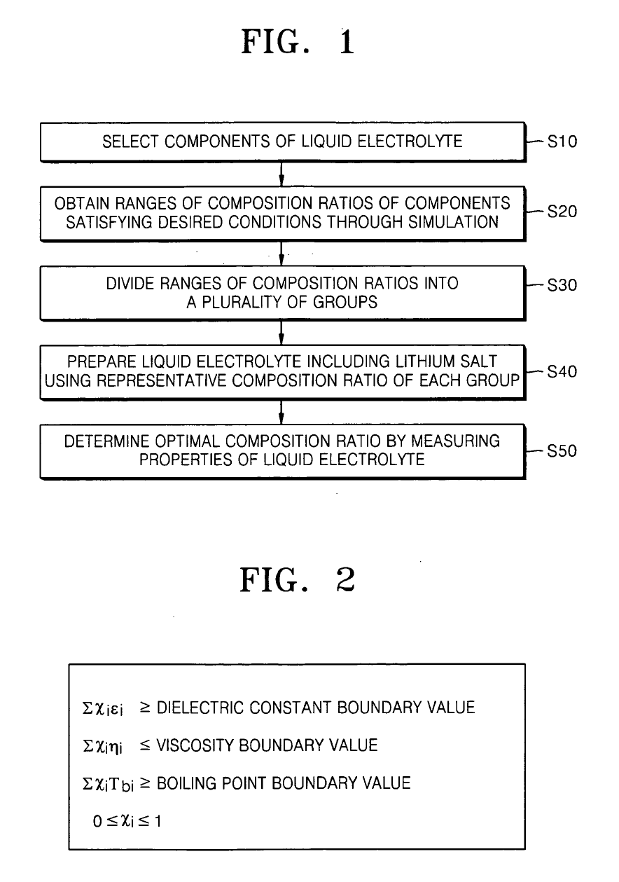

FIG. 1 is a flow chart illustrating a method of designing a composition of a liquid electrolyte for a high-speed charging/high-output discharging device according to an embodiment of the present invention.

Referring to FIG. 1, components of a nonaqueous organic solvent mixture of a liquid electrolyte are selected (S10). The nonaqueous organic solvent mixture includes, in addition to ethylene carbonate and dimethyl carbonate, an additional nonaqueous organic solvent having a high dielectric constant, a high boiling point, and low viscosity. The additional nonaqueous organic solvent may include one or more materials selected from the group consisting of diethyl carbonate, ethyl methyl carbonate, dimethylformamide, tetrahydrofuran, dimethyl acetylamide, n-butyl cabitol, n-methylpyrrolidone, 1,3-dioxolane, dimethyl ether, diethyl ether, and dimethyl sulfoxide.

After selecting the components of the liquid electrolyte, the dielectric constant, viscosity, and boiling point of the respective components are employed as input data and a simulation is performed to obtain the ranges of composition ratios of the respective components where the liquid electrolyte has desired average dielectric constant, desired average viscosity and desired average boiling point (S20). When the simulation for the composition ratio of the nonaqueous organic solvent mixture is performed, lithium salt is not included so as to simplify the calculating process. When the lithium salt is included in the simulation, the simulation process become complicated since the interaction between the lithium salt having polarity and organic solvents should be considered. When the simulation is performed only with organic solvents, however, average values of the properties of the liquid electrolyte may be easily predicted.

The obtained ranges of composition ratios are divided into groups having similar composition ratios and then a representative composition ratio of each group is determined (S30). In respective Examples to be described later, the ranges of the composition ranges are divided into 4 groups. However, the present invention is not limited thereto, and the number of composition ratio groups may be less than or greater than four. Then, a liquid electrolyte is formed according to the representative composition ratio of each composition ratio group (S40). In S40, a lithium salt is also included in the liquid electrolyte. The liquid electrolyte to which the lithium salt is included is evaluated in terms of physical, chemical, and electrical properties, such as ionic conductivity, viscosity, or discharge properties. As a result, a representative composition ratio having optimal properties is determined as an optimal composition ratio (S50).

FIG. 2 shows formulae used in an optimization program for a composition ratio simulation of a liquid electrolyte according to the present invention. As described above, a liquid electrolyte used in the simulation does not include a lithium salt. Referring to FIG. 2, denotes a component i in a nonaqueous organic solvent mixture, xᵢ denotes a composition ratio of the component i, eᵢ denotes dielectric constant of the component i, hᵢ denotes viscosity of the component i, and T_{bi} denotes a boiling point of the component i. Σxᵢeᵢ denotes an average dielectric constant of the nonaqueous organic solvent mixture which consists of components, Σxᵢhᵢ denotes an average viscosity of the nonaqueous organic solvent mixture which consists of components, ΣxᵢT_{bi} denotes an average boiling point of the nonaqueous organic solvent mixture which consists of components. Referring to FIG. 2, the composition ratio of components satisfies such conditions that an average dielectric constant of the nonaqueous organic solvent mixture is a boundary dielectric constant or greater, an average viscosity of the nonaqueous organic solvent mixture is a boundary value of viscosity or less, and an average boiling point of the nonaqueous organic solvent mixture is a boundary value of boiling point or less. When the composition ratio of components satisfies these formulae, Σxᵢ=1.

As for commercially available two-component-based and three-component-based liquid electrolytes, the average dielectric constant of the nonaqueous organic solvent mixture may be in the range of 47 to 48, the average viscosity of the nonaqueous organic solvent mixture may be in the range of 1.3 to 1.4 cP, and the average boiling point of the nonaqueous organic solvent mixture may be in the range of 60 to 70° C. Thus, in FIG. 2, the boundary value of dielectric constant may be set to 48, the boundary value of viscosity may be set to 1.3, and the boundary value of the boiling point may be set to 80. However, these boundary values may vary according to desired properties of the liquid electrolyte.

For example, a composition ratio of a three-component-based liquid electrolyte satisfying such conditions that the average dielectric constant is 48 or more, the average viscosity is 1.3 cP or lower, and the average boiling point is 80° C. or more, may be obtained using the following formulae in a simulation:

x_{A}e_{A}+x_{B}e_{B}+x_{C}e_{C}≧48;

x_{A}h_{A}+x_{B}h_{B}+x_{C}h_{C}≦1.30;

x_{A}T_{bA}+x_{B}T_{bB}+x_{C}T_{bC}≧80;

0≦x_{A}≦1;

0≦x_{B}≦1;

0≦x_{C}≦1; and

x_{A}+x_{B}+x_{C}=1

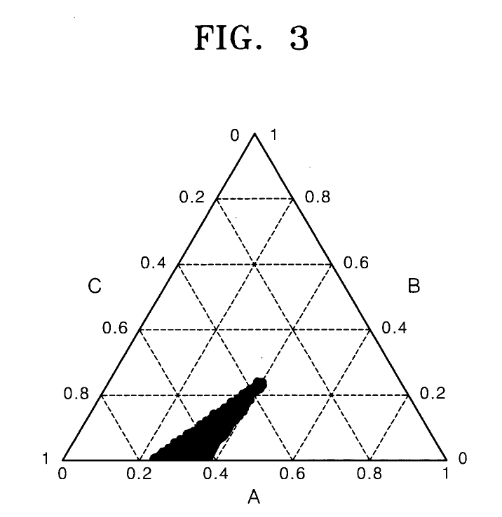

FIG. 3 is a triangular diagram illustrating a range of composition ratios of a three component-based liquid electrolyte obtained through an optimization program for a composition ratio simulation, according to an embodiment of the present invention. The three-component-based liquid electrolyte of FIG. 3 consists of ethylene carbonate, dimethyl carbonate, and dimethyl formamide. Ethylene carbonate has a dielectric constant of 88.78, viscosity of 1.90 cP, and a boiling point of 248° C.; dimethyl carbonate has a dielectric constant of 2.958, viscosity of 0.65, and a boiling point of 110° C.; and dimethyl formamide has a dielectric constant of 38.25, viscosity of 0.794, and a boiling point of 153° C. To optimize a composition ratio of the three-component-based liquid electrolyte of FIG. 3, the formulae shown in FIG. 2 are satisfied such that the average dielectric constant is 50 or more, the average viscosity is 1.2 or more, and the average boiling point is 100° C. or more.

Referring to FIG. 3, composition ratios satisfying such conditions were calculated and are illustrated in the triangular diagram having sides denoting components. The composition ratios satisfying such conditions are present within a predetermined region in the triangular diagram. As described with reference to the flow diagram of FIG. 1, the range of the composition ratios shown in the triangular diagram are divided into groups in which each group has a similar composition ratio and a representative composition ratio of each group may be determined. In the triangular diagram of FIG. 3, A denotes ethylene carbonate, B denotes dimethyl carbonate, and C denotes dimethyl formamide. Referring to the range of the composition ratio in FIG. 3, it may be identified that the range of ethylene carbonate is in the range of 0.2 to 0.4, the range of dimethyl carbonate is in the range of 0 to 0.25, and the range of dimethyl formamide is in the range of 0.35 to 0.8.

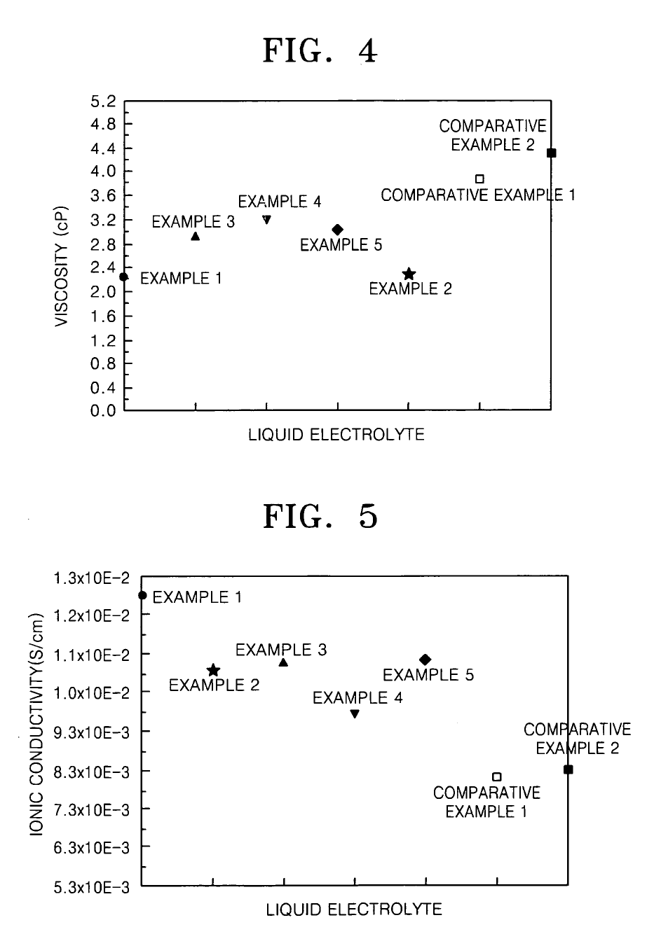

Hereinafter, methods of designing a liquid electrolyte composition for a high-speed charging/high-output discharging device according to the present invention will now be described in detail with reference to the examples below. These examples are for illustrative purposes only and are not intended to limit the scope of the present invention. The viscosity and ionic conductivity of a liquid electrolyte having an optimal composition ratio obtained according to the examples, and a specific capacity of a lithium single cell unit using the liquid electrolyte were measured and compared with those of a conventional liquid electrolyte. The results are shown in FIGS. 4, 5 and 6.

### EXAMPLE 1

A liquid electrolyte consisted of three organic solvents: ethylene carbonate, dimethyl carbonate, and dimethyl formamide. An optimization program for a composition ratio simulation was operated in which a three-component-based mode was selected, the dielectric constant, viscosity and boiling point of the three organic solvents were input, and a boundary condition was set such that the average dielectric constant was 50 or more, the average viscosity was 1.2 cP or lower, and the average boiling point was 80° C. or more. Then, a simulation was performed under the conditions described above and ranges of composition ratios of the three solvents were calculated. The results are illustrated in a three-component-based graph like FIG. 3. The amount of ethylene carbonate was calculated to be in the range of 23 to 40% by weight, the amount of dimethyl carbonate was calculated to be in the range of 1 to 24% by weight, and the amount of dimethyl formamide was calculated to be in the range of 36 to 77% by weight. The composition ratios obtained through the simulation of the optimization program are shown in Table 1.

As shown in Table 1, the composition ratios were divided into four groups and a representative composition ratio of each group was determined. Then, an organic solvent mixture was prepared using the respective representative composition ratios, and 1 M lithium salt was added thereto to prepare liquid electrolytes.

TABLE 1

| | Ethylene | Dimethyl | Dimethyl |
|---|---|---|---|
| | carbonate | carbonate | formamide |
| Group 1 | 25% by weight | 2% by weight | 73% by weight |
| Group 2 | 30% by weight | 9% by weight | 61% by weight |
| Group 3 | 35% by weight | 17% by weight | 48% by weight |
| Group 4^{#} | 40% by weight | 24% by weight | 36% by weight |

### EXAMPLE 2

A liquid electrolyte consisted of four organic solvents: ethylene carbonate, dimethyl carbonate, diethyl carbonate and ethylmethyl carbonate. An optimization program for a composition ratio simulation was operated in which a four-component-based mode was selected, the dielectric constant, viscosity and boiling point of the four organic solvents were input, and boundary conditions were set as in Example 1. The composition ratios obtained through the simulation of the optimization program are shown in Table 2, and divided into four groups and a representative composition ratio of each group was determined. Then, an organic solvent mixture was prepared using the respective representative composition ratios, and 1 M lithium salt was added thereto to prepare liquid electrolytes.

TABLE 2

| | | | Diethyl | Ethylmethyl |
|---|---|---|---|---|
| | Ethylene carbonate | Dimethyl carbonate | carbonate | carbonate |
| Group 1 | 53% by weight | 24% by weight | 1% by weight | 22% by weight |
| Group 2 | 53% by weight | 32% by weight | 2% by weight | 13% by weight |
| Group 3 | 53% by weight | 40% by weight | 1% by weight | 6% by weight |
| Group 4^{#} | 54% by weight | 44% by weight | 1% by weight | 1% by weight |

### EXAMPLE 3

A liquid electrolyte consisted of three organic solvents: ethylene carbonate, dimethyl carbonate and tetrahydrofurane. Representative composition ratios shown in Table 3 were obtained in the same manner as in Example 1. Liquid electrolytes were then prepared using the respective representative composition ratios.

TABLE 3

| | Ethylene carbonate | Dimethylcarbonate | Tetrahydrofurane |
|---|---|---|---|
| Group 1 | 15% by weight | 25% by weight | 60% by weight |
| Group 2 | 25% by weight | 20% by weight | 55% by weight |
| Group 3 | 35% by weight | 15% by weight | 50% by weight |
| Group 4^{#} | 45% by weight | 10% by weight | 45% by weight |

### EXAMPLE 4

A liquid electrolyte consisted of three organic solvents: ethylene carbonate, dimethyl carbonate and n-butyl carbitol. Representative composition ratios shown in Table 3 were obtained in the same manner as in Example 1. Liquid electrolytes were then prepared using the respective representative composition ratios.

TABLE 4

| | ethylene carbonate | dimethyl carbonate | n-butyl carbitol |
|---|---|---|---|
| Group 1 | 17% by weight | 20% by weight | 63% by weight |
| Group 2 | 23% by weight | 25% by weight | 52% by weight |
| Group 3 | 35% by weight | 15% by weight | 50% by weight |
| Group 4^{#} | 47% by weight | 12% by weight | 41% by weight |

### EXAMPLE 5

A liquid electrolyte consisted of three organic solvents: ethylene carbonate, dimethyl carbonate, and diethyl ether. Representative composition ratios shown in Table 3 were obtained in the same manner as in Example 1. Liquid electrolytes were then prepared using the respective representative composition ratios.

TABLE 5

| | Ethylene carbonate | Dimethyl carbonate | Diethyl ether |
|---|---|---|---|
| Group 1 | 13% by weight | 19% by weight | 68% by weight |
| Group 2 | 20% by weight | 17% by weight | 63% by weight |
| Group 3 | 31% by weight | 14% by weight | 55% by weight |
| Group 4^{#} | 45% by weight | 10% by weight | 45% by weight |

### COMPARATIVE EXAMPLE

The liquid electrolytes prepared according to Examples 1 through 5 were compared with a commercially available solution containing ethylene carbonate and dimethyl carbonate in a weight ratio of 1:1 in which 1 M lithium was dissolved (Comparative Example 1) and with a commercially available solution containing ethylene carbonate, dimethyl carbonate and diethyl carbonate in a weight ratio of 1:1:1 in which 1 M lithium was dissolved (Comparative Example 2).

FIG. 4 is a graph of viscosity of the liquid electrolytes prepared according to Examples 1 through 5 and Comparative Examples 1 and 2. Referring to FIG. 4 and Tables 1 through 5, the viscosity of a representative group which has highest viscosity and is marked by ‘#’ is shown. Referring to FIG. 4, the liquid electrolytes prepared according to Examples 1 through 5 have viscosity values ranging from about 2.2 to about 3.2 cP, but the liquid electrolytes prepared according to Comparative Examples 1 and 2 have viscosity values ranging from about 3.9 to about 4.3 cP. Therefore, it can be seen that the liquid electrolytes prepared according to Examples 1 through 5 have lower viscosity values than the liquid electrolytes prepared according to Comparative Example 1 and 2.

FIG. 5 is a graph of ionic conductivity of the liquid electrolytes prepared according to Examples 1 through 5 and Comparative Examples 1 and 2.

Referring to FIG. 5, the ionic conductivity of a representative group having highest discharging properties is shown. Referring to FIG. 5, the ionic conductivity of the liquid electrolytes prepared according to Examples 1 through 5 is in the range of about 9.5×10⁻³ to about 1.25×10⁻³ S/cm. On the other hand, the ionic conductivity of the liquid electrolytes prepared according to Comparative Examples 1 and 2 is in the range of 7.8×10⁻³ to 8.0×10⁻³ 10⁻³ S/cm. Therefore, it can be seen that the liquid electrolytes prepared according to Examples 1 through 5 have higher ionic conductivity than the liquid electrolytes prepared according to Comparative Examples 1 and 2.

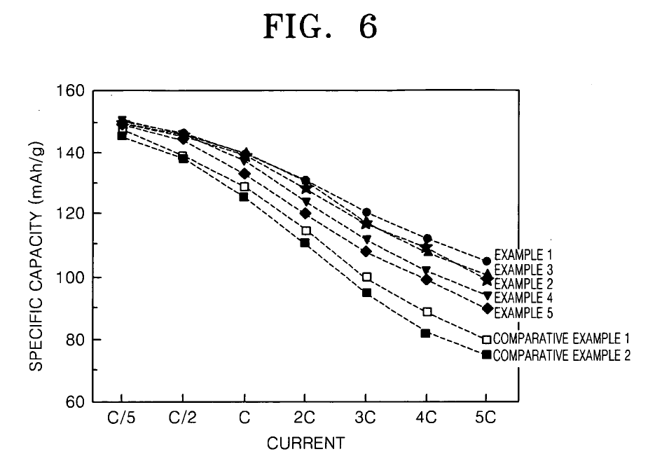

FIG. 6 is a graph illustrating discharging properties of lithium ion cells including liquid electrolytes prepared according to Examples 1 through 5 and Comparative Examples 1 and 2.

Referring to FIG. 6, the discharging property of a representative group having highest discharging properties is shown. Lithium ion single cell units were manufactured in a pouch shape having a size of 2 cm×2 cm using a lithium foil anode, a cobalt oxide cathode, and a liquid electrolyte. The liquid electrolytes prepared according to Examples 1 through 5 and Comparative Examples 1 and 2. The manufactured lithium ion single cell units were charged with 0.5 C of a current condition and then specific capacities thereof were measured while they were discharged at 0.5C, 1C, 2C, 3C, and 4C of current condition. C denotes a capacity of a lithium single cell unit. Referring to FIG. 6, a decrease in the specific capacity of a lithium single cell unit with respect to an increase in a discharge current was smaller when the liquid electrolytes prepared according to Examples 1 through 5 were used than when the liquid electrolytes prepared according to Comparative Examples 1 and 2 were used. That is, the lithium ion cells using the liquid electrolytes prepared according to Examples 1 through 5 have better capacity retaining properties during discharging than those of Comparative Examples 1 and 2.

As described above, a method of designing a liquid electrolyte according to the present invention allows a user to specify the composition ratio of a liquid electrolyte according to the objective in use. Specifically, a composition ratio of organic solvents of a liquid electrolyte satisfying desired conditions can be identified thorough a simulation, and thus an optimal composition ratio can be obtained thorough less trial and error and a smaller number of experiments. Therefore, the method is very useful for designing a composition of a liquid electrolyte.

Also, a liquid electrolyte composition prepared using the method described above has higher ionic conductivity, lower average viscosity, and excellent thermal stability than a conventional liquid electrolyte composition. In addition, when the liquid electrolyte composition according to the present invention is used to manufacture a single cell unit, an initial impedance is substantially decreased and an initial capacity is therefore increased when the single cell unit is formed, and excellent capacity maintaining properties can be obtained during high-speed charging and high-output discharging. Such results stem from an increase in the concentration of lithium ion in a liquid electrolyte due to an increase in the average dielectric constant, and an increase in mobility of the lithium ions due to a decrease in the average viscosity. Therefore, the present invention is very useful for realizing ultra high-speed charging within a few minutes and high-output discharging.

A method of designing a liquid electrolyte according to the present invention is in the form of a simulation and allows a user to be able to obtain a composition ratio of organic solvents of a liquid electrolyte satisfying desired conditions in advance. Therefore, the amount of trial and error and the number of experiments required to determine an optimal composition ratio can be reduced.

A liquid electrolyte prepared according to the method has higher ionic conductivity, lower viscosity, and high viscosity than a conventional liquid electrolyte. A cell prepared using such liquid electrolyte has low initial impedance and high initial capacity, and excellent capacity retaining properties during high-speed charging and high-output discharging operations.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A method of designing an electrolyte composition comprising a nonaqueous organic solvent mixture and a lithium salt, the method comprising:
selecting components of the nonaqueous organic solvent mixture;
determining ranges of composition ratios of the selected components satisfying Formulae 1 through 4 below;
dividing the ranges of the composition ratios into a plurality of groups;
selecting a representative composition ratio of each of the groups;
adding a lithium salt to a nonaqueous organic solvent mixture having the representative composition ratio to form an electrolyte composition; and
measuring properties of the electrolyte composition to determine a composition ratio of an electrolyte composition having predetermined properties:
Sxᵢeᵢ≧dielectric constant boundary value; Formula 1:
Sxᵢhᵢ≦viscosity boundary value; Formula 2:
SxᵢT_{b}≧boiling point boundary value; Formula 3:
0≦xᵢ≦1 Formula 4:
where i denotes a component i in the nonaqueous organic solvent mixture, xᵢ denotes a composition ratio of the component i, eᵢ denotes dielectric constant of the component i, hᵢ denotes viscosity of the component i, and T_{bi} denotes a boiling point of the component i.

2. The method of claim 1, wherein the dielectric constant boundary value is 48, the viscosity boundary value is 1.30, and the boiling point boundary value is 80.

3. The method of claim 1, wherein the nonaqueous organic solvent mixture comprises ethylene carbonate; dimethyl carbonate; and one or more materials selected from the group consisting of diethyl carbonate, ethylmethyl carbonate, dimethyl formamide, tetrahydrofurane, dimethylacetyl amide, n-butyl cabitol, n-methyl pyrrolidone, 1,3-dioxolane, dimehtyl ether, diethyl ether, and dimethyl sulfoxide.

4. The method of claim 1, wherein the lithium salt is added in a concentration of 0.1 M to 3M.

5. The method of claim 1, wherein the lithium salt comprises one or more materials selected from the group consisting of lithium perchlorate(LiClO₄), lithium triflate(LiCF₃SO₃), lithium hexafluorophosphate(LiPF₆), lithium tetrafluoroborate(LiBF₄) and lithium trifluoromethanesulfonimide (LiN(CF₃SO₂)₂).

6. The method of claim 1, wherein the dividing is performed with a boundary of the plurality of groups where the change in the composition ratio is large in the ranges of the composition ratios.

7. The method of claim 1, wherein the properties of the electrolyte composition comprise viscosity, ionic conductivity, and a specific capacity of a single cell unit.
